(19) United States
(12) Patent Application Publication
(10) Pub. No.: US 2023/0217556 A1
(43) Pub. Date: Jul. 6, 2023

(54) INDUCTION HEATING DEVICE AND METHOD OF CONTROLLING INDUCTION HEATING DEVICE

(71) Applicant: LG ELECTRONICS INC., Seoul (KR)

(72) Inventors: Kyelyong KANG, Seoul (KR); John Kang, Seoul (KR); Jinwook Han, Seoul (KR)

(21) Appl. No.: 18/093,129

(22) Filed: Jan. 4, 2023

(30) Foreign Application Priority Data
Jan. 5, 2022 (KR) 10-2022-0001830
May 24, 2022 (KR) 10-2022-0063646

(51) Int. Cl. H05B 6/08; H05B 6/06; H05B 6/42

(52) U.S. Cl. CPC H05B 6/08; H05B 6/062; H05B 6/42; H05B 2213/05

(57) ABSTRACT

An induction heating device according to an embodiment includes an inverter configured to supply an AC current to a working coil and includes a plurality of switches; a drive circuit configured to supply a switching signal for a switching operation of the plurality of switches to the inverter; and a controller configured to control driving of the working coil by supplying a control signal corresponding to a required power value of the working coil to the drive circuit. The controller may drive the working coil based on the required power value, receive a resonance current value of the working coil when the working coil is driven, calculate a container efficiency index based on an output power value of the working coil, the required power value, the resonance current value and a preset limit current value, and control the driving of the working coil based on the container efficiency index.

### CROSS-REFERENCE TO RELATED APPLICATION

This application claims priority to and the benefit of Korean Patent Application No. 10-2022-0001830, filed on Jan. 5, 2022, and Korean Patent Application No. 10-2022-0063646, filed on May 24, 2022, the disclosure of which are incorporated herein by reference in their entirety.

### TECHNICAL FIELD

The present disclosure relates to an induction heating device and a method for controlling an induction heating device.

### BACKGROUND

An induction heating device generates eddy currents in a metallic container by using a magnetic field that is created around a working coil, to heat the container. As an induction heating device operates, alternating current (AC) currents are supplied to the working coil. As the AC currents are supplied to the working coil, an induced magnetic field is created around the working coil. As the magnetic line of force of the induced magnetic field, created around the working coil, passes through the bottom surface of the metallic container placed on the working coil, eddy currents are generated in the container. As the eddy currents flow in the container, the container is heated by Joule heat that is generated by the resistance of the container.

Since the container can be heated only when eddy currents are formed in the container by the magnetic field of the working coil, types of containers that can be used in the induction heating device are limited, for example, containers made of materials such as cast iron or casing having high heating efficiency due to their high magnetism. However, containers made of stainless steel have low heating efficiency due to low magnetism.

When a user uses a container having low heating efficiency, the heating rate of the container may decrease or the temperature of the container may not rise above a predetermined temperature. In this case, since it is difficult for the user to recognize the cause of the decrease in heating rate or decrease in container temperature, there is a need of providing the user with accurate information about the characteristics and heating efficiency of the container.

Meanwhile, a user who wants to heat a container using the induction heating device sets a power level corresponding to the thermal power to be supplied to the container. The induction heating device drives the working coil based on a required power value corresponding to the power level set by the user.

Even though the same amount of power is supplied to the working coil driven to heat a container, the size (or magnitude) of the thermal energy supplied to the container could vary based on the characteristics of the container, such as the size, location and material of the container. The energy generated by the working coil but not delivered to the container may circulate in a circuit provided in the induction heating device. This may result in the working coil or components disposed around the working coil to have high temperatures or be damaged due to the energy not being delivered to the container, but instead circulating in the circuit.

### SUMMARY

One aspect of the present disclosure is to provide an induction heating device that may provide a user with accurate information about heating efficiency based on characteristics of a container, and a method of controlling the induction heating device.

Another aspect of the present disclosure is to provide an induction heating device that may prevent temperature rise or damage of components disposed around a working coil by reducing heat generated inside the induction heating device when a container having low heating efficiency is heated, and a method of controlling the induction heating device.

Aspects according to the present disclosure are not limited to the above ones, and other aspects and advantages that are not mentioned above may be clearly understood from the following description and may be more clearly understood from the embodiments set forth herein.

An induction heating device according to an embodiment may include an inverter configured to supply an AC current to a working coil and comprises a plurality of switches; a drive circuit configured to supply a switching signal for a switching operation of the plurality of switches to the inverter; and a controller configured to control driving of the working coil by supplying a control signal corresponding to a required power value of the working coil to the driver.

The controller may drive the working coil based on the required power value, receive a resonance current value of the working coil when the working coil is driven, calculate a container efficiency index based on an output power value of the working coil, the required power value, the resonance current value and a preset limit current value, and control the driving of the working coil based on the container efficiency index.

The controller may compare the resonance current value to a preset first reference value. When the resonance current value is greater than the preset first reference value based on the result of the comparison, the controller may calculate the container efficiency index.

The container efficiency index is defined as in [Equation 1] below:

PEI=(PR/PC)×(RI/CI) [Equation 1]

(PEI refers to the container efficiency index and PR refers to the output power value of the working coil WC. PC refers to the required power value of the working coil WC and RI refers to the preset limit current value. CI refers to the resonance current value of the working coil WC.)

The controller may calculate an adjustment value based on the container efficiency index, and adjust the required power value by subtracting the adjustment value from the required power value.

The adjustment value may be defined as in [Equation 2] below:

K=D/PEI [Equation 2]

(K refers to the adjustment value and D refers to a preset basic adjustment value. PEI refers to the container efficiency index.)

The controller may adjust a rotational speed of the cooling fan based on the container efficiency index.

The rotational speed of the cooling fan may be inversely proportional to the container efficiency index.

When the container efficiency index is smaller than a preset third reference, the controller may decrease a preset second reference.

When the resonance current value is greater than the preset second reference value, the controller may decrease an output power value of the working coil.

When the required power value is determined, the controller may increase the output power value until the output power value of the working coil becomes equal to the required power value. When the container efficiency index is smaller than a preset fourth reference value after the output power value becomes equal to the required power value, the controller may adjust the output power value to be a value smaller than the required power value.

A method of controlling an induction heating device according to an embodiment may include driving a working coil based on a required power value; measuring a resonance current value of the working coil when the working coil is driven; calculating a container efficiency index based on an output power value of the working coil, the required power value, the resonance current value and a preset limit current value; and controlling driving of the working coil based on the container efficiency index.

The container efficiency index is defined as in [Equation 1] below:

PEI=(PR/PC)×(RI/CI) [Equation 1]

(PEI refers to the container efficiency index and PR refers to the output power value of the working coil WC. PC refers to the required power value of the working coil WC and RI refers to the preset limit current value. CI refers to the resonance current value of the working coil WC.)

The container efficiency index may be calculated when the resonance current value is greater than a preset first reference value.

The controlling the driving of the working coil based on the container efficiency index may comprise calculating an adjustment value based on the container efficiency index and adjusting the required power value by subtracting the adjustment value from the required power value.

The adjustment value may be defined as in [Equation 2] below:

K=D/PEI [Equation 2]

(K refers to the adjustment value and D refers to a preset basic adjustment value. PEI refers to the container efficiency index.)

The method of controlling the induction heating device may further include adjusting a rotational speed of the cooling fan based on the container efficiency index.

The rotational speed of the cooling fan may be inversely proportional to the container efficiency index.

The controlling the driving of the working coil based on the container efficiency index may include decreasing a preset second reference when the container efficiency index is smaller than a preset third reference and decreasing an output power value of the working coil when the resonance current value is greater than the preset second reference value.

The driving the working coil based on the required power value may include increasing the output power value until the output power value of the working coil becomes equal to the required power value, when the required power value is determined.

The controlling the driving of the working coil based on the container efficiency index may include adjusting the output power value to be a value smaller than the required power value, when the container efficiency index is smaller than a preset fourth reference value after the output power value becomes equal to the required power value.

According to the embodiments, the user may be provided with accurate information about heating efficiency based on characteristics of a container.

In addition, according to the embodiments, the heat generated inside the induction heating device when a container having low heating efficiency is heated may be reduced. Accordingly, the temperature rise or damage of components disposed around a working coil may be prevented.

### BRIEF DESCRIPTION OF DRAWINGS

FIG. 1 is an exploded perspective view of an induction heating device according to an embodiment;

FIG. 2 is a circuit diagram of an induction heating device according to an embodiment;

FIG. 3 is a flow chart showing a method of controlling an induction heating device according to an embodiment;

FIG. 4 is a flow chart showing a method of controlling an induction heating device according to another embodiment;

FIG. 5 is a flow chart showing a method of controlling an induction heating device according to a further embodiment;

FIG. 6 is a graph showing a required power value corresponding to a power level set by a user and a working coil driven based on the required power value according to an embodiment;

FIG. 7 shows an upper plate of an induction heating device according to an embodiment; and

FIG. 8 shows a display provided in an induction heating device according to an embodiment.

### DETAILED DESCRIPTION

The above-described aspects, features and advantages may be described hereunder with reference to the accompanying drawings such that one having ordinary skill in the art to which the present disclosure pertains may easily implement the technical spirit of the disclosure. In the disclosure, detailed description of known technologies in relation to the disclosure may be omitted if they are deemed to make the gist of the disclosure unnecessarily vague. Below, preferred embodiments according to the disclosure are specifically described with reference to the accompanying drawings and should not be construed as limiting the scope of the disclosure. In the drawings, identical reference numerals may denote identical or similar components.

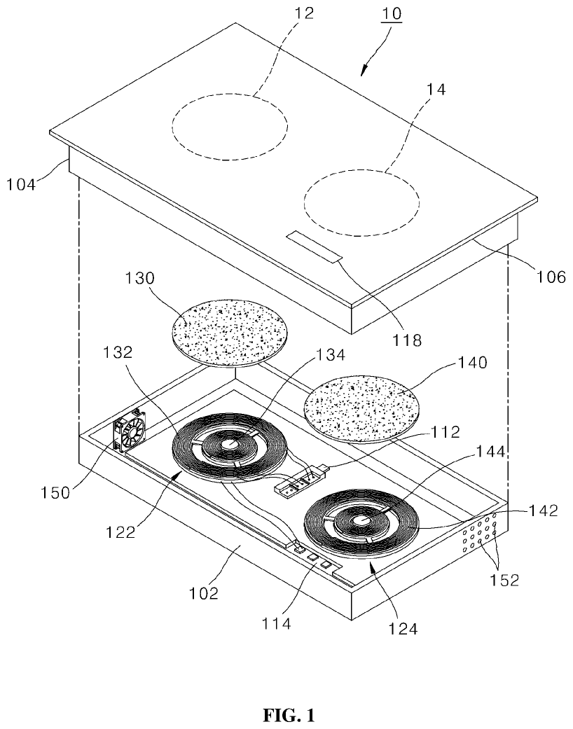

FIG. 1 is an exploded perspective view of an induction heating device according to an embodiment.

The induction heating apparatus 10 according to an embodiment may include a case 102 defining a body thereof and a cover plate 104 coupled to the case 102 to seal the case 102.

The cover plate 104 may be coupled to an upper surface of the case to close the space formed inside the case 102 from the outside environment. The cover plate 104 may include a top plate 106 on which a container for cooking food is placed. The top plate 106 may be made of a tempered glass material such as ceramic glass, but is not limited thereto. The material of the top plate 106 may vary according to embodiments.

Heating regions 12 and 14 corresponding to working coil assemblies 122 and 124, respectively, may be formed at the top plate 106. Lines or figures corresponding to the heating regions 12 and 14 may be printed or displayed on the top plate 106 in order for a user to clearly recognize the positions of the heating regions 12 and 14.

The case 102 may have a hexahedral shape with an open top. The working coil assemblies 122 and 124 for heating a container or vessel may be disposed in the space formed inside the case 102. In addition, an interface 114 may be provided inside the case 102 and have functions to adjust a power level of each heating region 12 and 14 and display related information of the induction heating apparatus 10. The interface 114 may be a touch panel that is capable of both inputting information and displaying information by touch, but the interface 114 having a different structure may be provided according to embodiments.

A manipulation region 118 may be formed in a position corresponding to the interface 114 at the top plate 106. For user manipulation, characters or images may be printed on the manipulation region 118. The user may perform a desired operation by touching a specific point of the manipulation region 118 with reference to the characters or images pre-printed on the manipulation region 118.

The user may set the power level of each heating region 12 and 14 through the interface 114. The power level may be indicated by a number (e.g., 1, 2, 3, . . . , 9) on the manipulation region 118. When the power level for each heating region 12 and 14 is set, the required power value and the heating frequency of the working coil assemblies responding to the respective heating regions 12 and 14 may be determined. A controller may drive each working coil so that the actual output power value may match the required power value set by the user based on the determined heating frequency.

In the space formed inside the case 102, there may be further provided a power source part 112 for supplying power to the working coil assemblies 122 and 124 or the interface 114.

In the embodiment of FIG. 1, two working coil assemblies (i.e., a first working coil assembly 122 and a second working coil assembly 124) are disposed inside the case 102. However, three or more working coil assemblies may be provided in the case 102 according to other embodiments.

Each working coil assembly 122 and 124 may include a working coil configured to induce a magnetic field using a high frequency alternating current supplied by the power source part 112, and an insulating sheet configured to protect the coil from heat generated by the container. For example, the first working coil assembly 122 shown in FIG. 1 may include a first working coil 132 for heating the container put on the first heating region 12 and a first insulating sheet 130. The second working coil assembly 124 may include a second working coil 142 and a second insulating sheet 140. The insulating sheet may not be provided according to embodiments.

In addition, a temperature sensor may be provided at the center of each working coil. For example, a temperature sensor 134 may be provided in the center of the first working coil 132 as shown in FIG. 1. Another temperature sensor 144 may be provided in the center of the second working coil 142. The temperature sensor may measure the temperature of the container put on each heating region. In one embodiment of the present disclosure, the temperature sensor may be a thermistor temperature sensor having a variable resistance of which a resistance value changes according to the temperature of the container, but is not limited thereto.

In the embodiment, the temperature sensor may output a sensing voltage corresponding to the temperature of the container and the sensing voltage output from the temperature sensor may be transmitted to the controller. The controller may check the temperature of the container based on the magnitude of the sensing voltage output from the temperature sensor. When the temperature of the container is a preset reference value or more, the controller may perform an overheat preventing operation of lowering an output power value of the working coil or stopping the driving of the working coil.

Although not shown in the drawings, a circuit board on which a plurality of circuits or elements including a controller may be disposed in the space formed inside the case 102. For example, the controller may be a microprocessor or a logic circuit.

The controller may perform a heating operation by driving each working coil based on the user's heating start command input through the interface 114. When the user inputs a heating terminating command through the interface 114, the controller may stop the driving of the working coil to terminate the heating operation.

A cooling fan 150 may be disposed in a space formed inside the case 102. A third temperature sensor may be disposed inside the case 102. For example, the third temperature sensor may be disposed on a predetermined area of a circuit board provided inside the case 102. The controller may drive the cooling fan 150, when temperature values or temperature change rates that are measured by three temperature sensors are equal to or more than a preset reference value. When the cooling fan 150 is driven, the cold air generated by the cooling fan 150 may be supplied in a direction toward the circuit board provided inside the case 102 to cool the working coils 132 and 142 or the components disposed around the working coils 132 and 142. The air after cooling the circuit board may be discharged to the outside of the case 102.

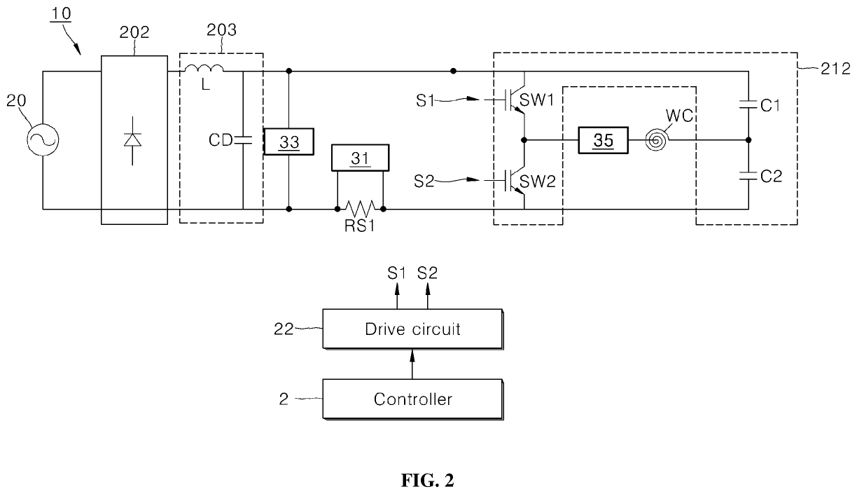

FIG. 2 is a circuit diagram of an induction heating device according to an embodiment.

The induction heating apparatus 10 according to one embodiment may include a rectifier circuit 202, a smoothing circuit 203, an inverter (or an inverter circuit) 212, a working coil WC, a controller 2 and a driver circuit 22.

The rectifier circuit 202 may include a plurality of diodes. According to the embodiment, the rectifier circuit 202 may be a bridge diode circuit, but it may be another type of circuit according to other embodiments. The rectifier circuit 202 may be configured rectify the AC input voltage supplied from a power source 20, thereby outputting a voltage having a pulsating waveform.

The smoothing circuit 203 may smooth the voltage rectified by the rectifier circuit 202 and output a DC link voltage. The smoothing circuit 203 may include an inductor L and a DC link capacitor CD.

The inverter 212 may include a first switch SW1, a second switch SW2, a first capacitor C1 and a second capacitor C2. The first switch SW1 may be connected in series to the second switch SW2. The first capacitor C1 may be connected in series to the second capacitor C2. The working coil WC may be connected between the connection point of the first switch SW1 and the second switch SW2, and the connection point of the first capacitor C1 and the second capacitor C2. The inverter 212 may convert the current output from the smoothing circuit 204 into AC current, and may supply the converted AC current to the working coil WC.

In an embodiment, the first switch SW1 and the second switch SW2 may be alternately turned on and off.

The controller 2 may be configured to output a control signal for controlling the drive circuit 22. The drive circuit 22 may supply switching signals S1 and S2 to the switches SW1 and SW2, respectively, based on the control signal supplied by the controller 2. The first switching signal S1 and the second switching signal S2 may be Pulse Width Modulation (PWM) signals having a predetermined duty cycle.

When receiving the AC current output from the inverter 212, the working coil WC may be driven. When the working coil WC is driven, eddy currents may flow through the container put on the working coil WC to heat the container. The size (or magnitude) of the thermal energy supplied to the container may vary based on the size of the power substantially generated by the working coil WC when the working coil WC is driven, that is, actual output power value of the working coil.

For example, when the user changes an operation state of the induction heating device 10 into a Power On state through the manipulation region 118, power may be supplied to the induction heating device 10 from an external power supply 20 and the induction heating device 10 may enter a driving standby state. Hence, the user may put a container on the first heating region 12 and/or the second heating region 14 provided at the induction heating device 10 and set a power level for the first heating region 12 and/or the second heating region 14 to input a heating-start command Once the user inputs the heating-start command, the controller 2 may determine a required power value of the working coil WC corresponding to the power level set by the user.

Upon receiving the heating-start command, the controller 2 may determine a frequency corresponding to the required power value of the working coil WC, that is, a heating frequency, and may supply a control signal corresponding to the determined heating frequency to the drive circuit 22. Accordingly, switching signals S1 and S2 may be output from the drive circuit 22, and may be input to the switches SW1 and SW2, respectively, to drive the working coil WC. When the working coil WC is driven, the container put on the working coil WC may be heated.

In an embodiment, the induction heating device 10 may include a shunt resistance RS1. The shunt resistance RS1 may be connected between the smoothing circuit 203 and the inverter 212.

In an embodiment, the induction heating device 10 may include an input current sensor 31 configured to sense the size of current flowing through the shunt resistance RS1, that is, a current value. The controller 2 may be configured to sense the size of the current input to the working coil WC based on the current value sensed through the shunt resistor RS1.

In an embodiment, the controller 2 may sense the size of the voltage applied to both ends of the DC link capacitor CD by using a voltage sensor 35.

In an embodiment, the controller 2 may determine an output power value of the working coil WC based on [Equation 1].

P=V_{dc}I_{avg} [Equation 1]

In [Equation 1], P refers to an output power value of the working coil WC. Vdc refers to the size of the voltage applied to both ends of the DC link capacity CD, that is, a DC link voltage value. Iavg refers to an average value of the current value sensed at the shunt resistor RS1.

The method in which the controller 2 calculates the output power value of the working coil WC based on [Equation 1] is just one of the examples. The controller 2 may calculate the output power value of the working coil WC based on other methods known in the art.

In an embodiment, the controller 2 may measure the size of resonance current generated by the working coil WC, that is, a resonance current value of the working coil WC by using a resonance current sensor 35, when the working coil WC is driven. The controller 2 may calculate a container efficiency index based on the resonance current value measured by the resonance current sensor 35. The controller 2 may adjust an output power value of the working coil WC based on the resonance current value measured by the resonance current sensor 35.

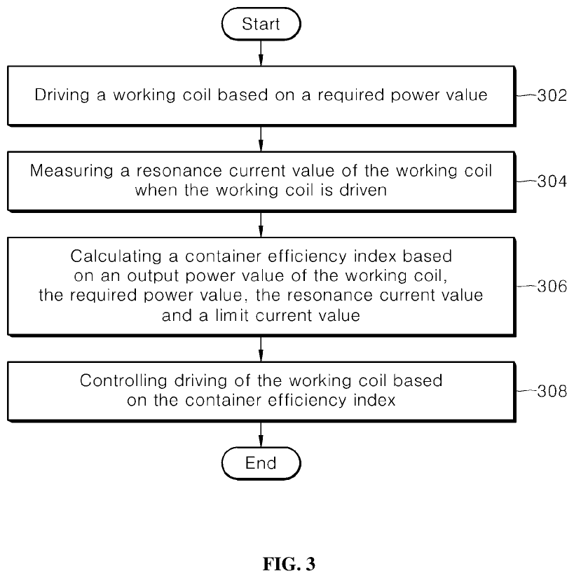

FIG. 3 is a flow chart showing a method of controlling an induction heating device according to an embodiment.

When the user places a container on the working coil WC and sets a power level, the controller 2 may determine a required power value corresponding to the set power level. The controller 2 may drive the working coil WC based on the determined required power value (302).

When the working coil WC is driven, the controller 2 may measure a resonance current value of the working coil WC by using the resonance current sensor 35 (304).

The controller 2 may calculate a container efficiency index based on an output power value, a required power value and a resonance current value of the working coil WC and a preset limit current value (306).

In an embodiment, the controller may compare the resonance current value to a preset first reference value, and may calculate a container efficiency index when the resonance current value is greater than the preset first reference value based on the result of comparison.

In an embodiment, the container efficiency index may be defined as in [Equation 2] below.

[Equation 2]

Here, PEI refers to the container efficiency index and PR refers to the output power value of the working coil WC. PC refers to the required power value of the working coil WC and RI refers to the preset limit current value. CI refers to the resonance current value of the working coil WC.

The resonance current value as well as the output value of the working coil WC is reflected in the container efficiency index defined in [Equation 2]. Accordingly, the user may be provided with accurate information about the heating efficiency of the container placed on the working coil WC.

In [Equation 2], (PR/PC) refers to the rate of the actual output power value (PR) of the working coil WC to the required power value (PC) of the working coil WC. In other words, the working coil WC is driven based on the required power value PC. Then, the closer the actual output power value PR of the working coil WC is to the required power value PC, the higher the heating efficiency of the container is. In an embodiment, a relational expression of (PR/PC)≤1 may be established.

In [Equation 2], (RI/CI) is the rate of the limit current value to the resonance current value of the working coil WC. The limit current value is a preset value and it may be set to be variable according to embodiments. As will be described later, the controller 2 may reduce the output power value of the working coil WC, when the resonance current value is greater than a preset reference value, to prevent the temperature rise of the components around the working coil WC. In other words, if the resonance current value of the working coil WC is high even when the (PR/PC) value is high, the output power value of the working coil WC may be low. Accordingly, when the (RI/CI) value is reflected in the container efficiency index, the actual output value of the working coil WC based on the output control based on the resonance current value of the working coil WC may be accurately predicted.

In an embodiment, a relational expression of (PR/CI)≥1 may be established. The greater the resonance current value is, the smaller the (RI/CI) value is. The smaller the resonance current value is, the greater the (RI/CI) value is.

The controller 2 may control the driving of the working coil WC based on the calculated container efficiency index (308).

In an embodiment, the operation of controlling the driving of the working coil WC based on the container efficiency index (308) may include calculating an adjustment value based on the container efficiency index and adjusting the required power value by subtracting the adjustment value from the required power value.

In an embodiment, the adjustment value may be defined as [Equation 3] below.

[Equation 3]

Here, K refers to the adjustment value and D refers to a preset basic adjustment value. PEI refers to the container efficiency index.

In [Equation 3], the preset basic adjustment value D may be set to be variable according to embodiments.

In an embodiment, the controller 2 may adjust a rotational speed of the cooling fan 150 based on the container efficiency index. In an embodiment, the rotational speed of the cooling fan 150 may be inversely proportional to the container efficiency index.

The container is heated by the working coil WC. At this time, the lower the container efficiency index is, the greater the resonance current value of the working coil WC is. As the resonance current value becomes greater, the energy generated by the working coil WC is not transferred to the container, only to increase the thermal energy of the working coil WC or components around the working coil WC. Accordingly, the possibility of overheating or damage to the components disposed around the working coil WC could increase. The controller 2 may suppress the temperature rise of the components around the working coil WC by increasing the rotational speed of the cooling fan 150, as the container efficiency index becomes lower.

When the rotational speed of the cooling fan 150 is controlled based on the container efficiency index, the rotational speed of the cooling fan 150 may be adjusted in advance before the temperature of the components around the working coil WC rises. Due to this structure, it may be possible to preemptively suppress the temperature rise of the components around the working coil WC.

In an embodiment, the operation of controlling the driving of the working coil WC based on the container efficiency index (308) may include reducing a preset second reference value when the container efficiency index is smaller than a preset third reference value; and reducing the output power value of the working coil WC, when the resonance current value is greater than the preset second reference value.

As described above, as the resonance current value becomes greater when the working coil WC is driven, the temperature of the components around the working coil WC could rise. Accordingly, the controller 2 may lower the resonance current value of the working coil WC by lowering the output current value of the working coil WC, when the resonance current value is greater than the preset second reference value.

As described above, as the resonance current value of the working coil WC becomes greater, the container efficiency index becomes smaller. When the container efficiency index is smaller than the preset third reference value, the controller 2 may decrease the preset second reference value. The lower the container efficiency index is, the lower the preset second reference value is. Accordingly, the controller may preemptively suppress the temperature rise of the components around the working coil WC during the driving process of the working coil WC.

In an embodiment. The operation of driving the working coil WC based on the required power value may include increasing the output power value until the output power value of the working coil is equal to the required power value after the required power value is determined. The operation of controlling the driving of the working coil WC based on the container efficiency index (308) may further include adjusting the output power value to be a smaller value than the required power value, when the output power value of the working coil WC is equal to the required power value.

As described above, as the container efficiency index is lower and lower (i.e., the resonance current value is higher and higher), the controller 2 may lower the output power value of the working coil WC based on the resonance current value. In this instance, when the output power value of the working coil WC becomes lower, the heating speed of the container heated by the working coil WC could decrease or the temperature of the container could not rise sufficiently. Accordingly, when the container efficiency index is smaller than a preset fourth reference value at the time the output power value of the working coil WC is equal to the required power value, the controller 2 may adjust in advance the output power value to be a value smaller than the required power value, thereby preventing sudden output deterioration of the working coil WC due to the control based on the resonance current value.

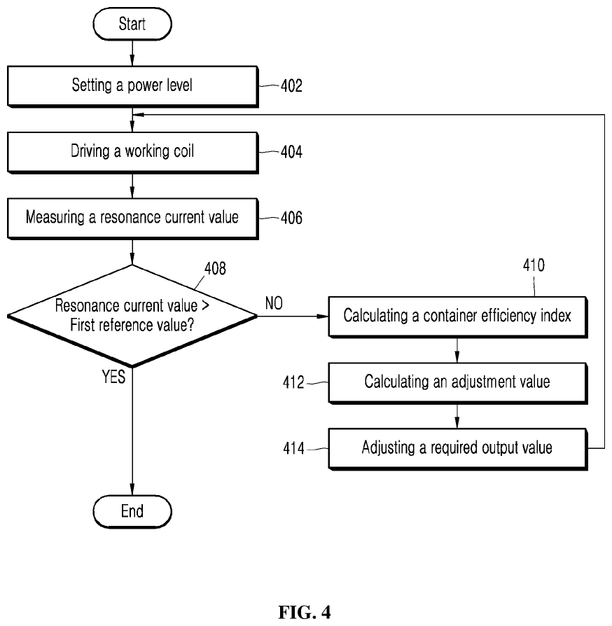

FIG. 4 is a flow chart showing a method of controlling an induction heating device according to another embodiment.

The user may place a container on the working coil WC and set a power level through the manipulation region 118 (402).

When the power level is set, the controller 2 may determine a required power value corresponding to the power level set by the user, and may drive the working coil WC based on the determined required power value (404). For example, the controller 2 may gradually increase the output power value of the working coil WC until the output power value of the working coil WC is equal to the required power value.

When the working coil WC is driven, the controller 2 may measure a resonance current value of the working coil WC by using the resonance current sensor 35 (406).

The controller 2 may compare the measured resonance current value to a preset first reference value (408). When the resonance current value is smaller than the preset first reference value based on the result of the comparison, the controller 2 may constantly drive the working coil WC based on the required power value.

When the resonance current value is greater than the preset first reference value based on the result of the comparison (408), the controller 2 may calculate a container efficiency index (410). In an embodiment, the controller 2 may calculate the container efficiency index based on the output power value, the required power value and the resonance current value of the working coil WC and a preset limit current value. For example, the container efficiency index may be defined as in [Equation 2] above.

After calculating the container efficiency index, the controller may calculate an adjustment value based on the container efficiency index (412). In an embodiment, the controller 2 may calculate the adjustment value based on [Equation 3].

The controller 2 may adjust the required power value by subtracting the adjustment value from the required power value (414). After adjusting the required power value, the controller 2 may perform the operation (404) again.

According to the embodiment shown in FIG. 4, when the container having low container efficiency index is heated, the required power value may become smaller. Accordingly, when the container having the low container efficiency index is heated, the possibility of overheating or damage to the components around the working coil WC may be reduced.

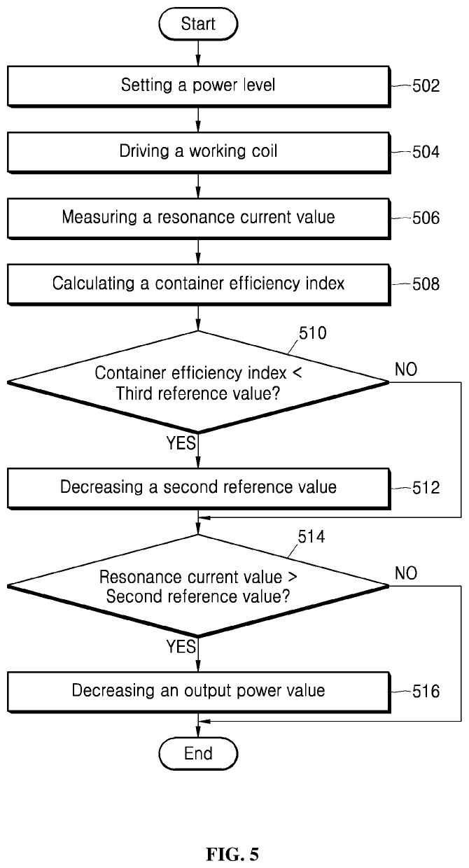

FIG. 5 is a flow chart showing a method of controlling an induction heating device according to a further embodiment.

The user may place a container on the working coil WC and set a power level through the manipulation region 118 (502).

When the power level is set, the controller 2 may determine a required power value corresponding to the power level set by the user, and may drive the working coil WC based on the determined required power value (504). For example, the controller 2 may gradually increase the output power value of the working coil WC until the output power value of the working coil WC is equal to the required power value.

When the working coil WC is driven, the controller 2 may measure a resonance current value of the working coil WC by using the resonance current sensor 35 (506).

The controller 2 may calculate a container efficiency index (508). In an embodiment, the controller 2 may calculate the container efficiency index based on the output power value, the required power value and the resonance current value of the working coil WC and a preset limit current value. For example, the container efficiency index may be defined as in [Equation 2] above.

The controller 2 may compare the calculated container efficiency index to a preset third reference value (510). Unless the container efficiency index is smaller than the preset third reference value based on the result of the comparison, the controller 2 may perform the operation (514). When the container efficiency index is smaller than the preset third reference value based on the result of the comparison operation (510), the controller 2 may decrease the preset second reference value (512).

The controller 2 may compare the resonance value to the preset second reference value (514). Unless the resonance current value is greater than the preset second reference value based on the result of the comparison operation (514), the controller may constantly drive the working coil WC based on the required power value. When the resonance current value is greater than the preset second reference value based on the result of the comparison, the controller 2 may decrease the output power value of the working coil WC (516).

According to the embodiment shown in FIG. 5, when the resonance current value of the working coil WC is greater than the preset second reference value, the output power value of the working coil WC may be decreased. Accordingly, the overheating of the working coil WC or the damage to the components around the working coil WC may be prevented.

According to the embodiment shown in FIG. 5, when the container efficiency index is smaller than the preset third reference value, the preset second reference value may be decreased. When the container having low container efficiency index is heated, the resonance current value of the working coil WC and the temperature of the working coil WC could be suddenly increased. Accordingly, the controller may decrease the preset second reference value when heating the container having a container efficiency index, thereby preventing the sudden increase of the resonance current value of the working coil WC and the sudden temperature rise of the working coil. Accordingly, the possibility of overheating or damage to the components around the working coil WC may be reduced.

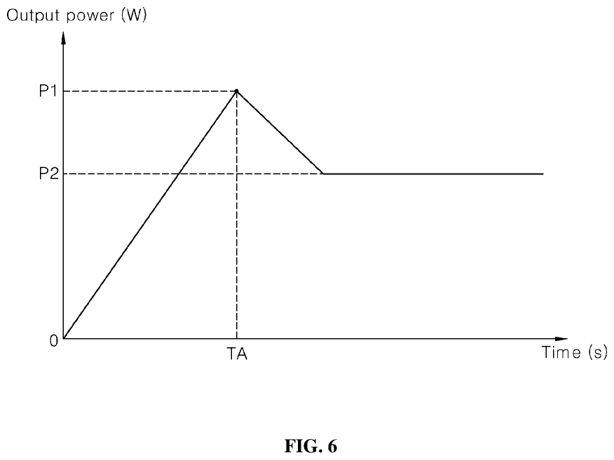

FIG. 6 is a graph showing a required power value corresponding to a power level set by a user and a working coil driven based on the required power value according to an embodiment.

When a power level is set by the user, the controller 2 may determine a required power value corresponding to the power level set by the user, and may drive the working coil WC based on the required power value. For example, as shown in FIG. 6, the controller 2 may gradually increase the output power value of the working coil WC from 0 (zero) until the output power value of the working coil WC is equal to the required power value.

If the required power value is P1, the controller 2 may gradually increase the output power value of the working coil WC from 0 to P1. When the output power value of the working coil WC becomes P1 at a time point TA, the controller 2 may calculate the container efficiency index. In an embodiment, the controller may calculate the container efficiency index based on the output power value, the required power value and the resonance current value of the working coil WC and a preset limit current value. For example, the controller 2 may calculate the container efficiency index based on [Equation 2].

The controller 2 may compare the calculated container efficiency index to a preset third reference value. When the container efficiency index is smaller than a fourth reference value based on the result of the comparison, the controller 2 may gradually decrease the output power value of the working coil WC to a value smaller than the required power value of the working coil WC (e.g., P1).

As described above referring to FIG. 5, when the container efficiency index is low (i.e., when the resonance current value is higher), the controller 2 may lower the output power value of the working coil WC based on the resonance current value. At this time, if the output power value of the working coil WC is suddenly lowered, the heating speed of the container heated by the working coil WC could deteriorate or the temperature of the container could not rise sufficiently. Accordingly, like the embodiment of FIG. 6, the controller 2 may adjust in advance the output power value to be a value (e.g., P2) smaller than the required power value, when the container efficiency index is smaller than the present fourth reference value after the output power value of the working coil WC becomes equal to the required power value (e.g., P1). Accordingly, sudden output deterioration of the working coil WC due to the sudden increase of the resonance current value may be prevented.

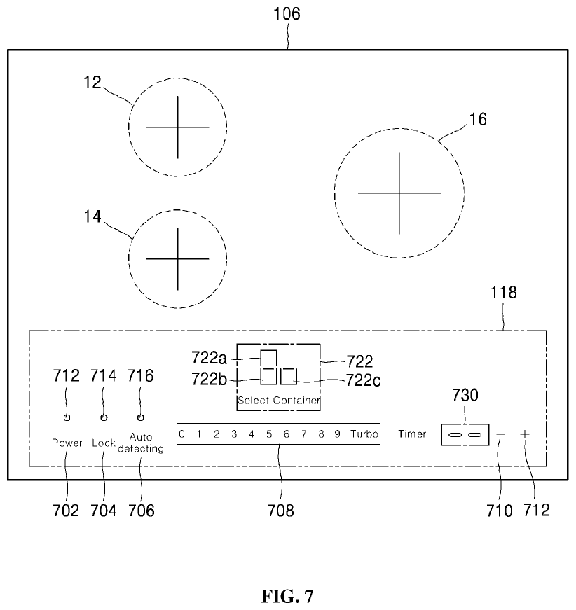

FIG. 7 shows an upper plate of an induction heating device according to an embodiment.

Referring to FIG. 7, three heating regions 12, 14 and 16 may be disposed on the upper plate 106 of the induction heating device according to an embodiment. In addition, a manipulation region 118 may be disposed on the upper plate 106 to control the heating operation for the container disposed on the heating region 12, 14 and 16.

A button and a display portion may be disposed in the manipulation region 118 to control the heating operation for the container. The user may apply or cut off power to the induction heating device by touching a power button 702. Whether or not power is applied may be displayed by whether or not a power lamp 712 is illuminated.

In addition, the user may change a current state of the manipulation region 118 to a locked state or an unlocked state by touching a lock button 704 for a preset time period. When the manipulation region 118 is in the locked state, input to all the buttons provided in the manipulation region 118 may be shut off. The locked state of the induction heating device may be displayed by illumination of the lock button 714.

The user may set or cancel a container automatic sensing function by touching an automatic sensing button 706. When the container automatic sensing function is set and a container is placed on the heating region 12, 14 and 16, whether or not the container is useable may be displayed on the heating region select window 722.

The user may select the heating region to heat by touching heating region selection buttons 722a, 722b and 722c corresponding to the heating regions 12, 14 and 16, respectively. Then, the user may set an output level for the selected heating region by touching an output level set button 708.

In addition, the user may set a timer for the selected heating region by touching timer buttons 710 and 712. The time set by the user using the timer buttons 710 and 712 may be displayed on a timer window 730.

The user may check the container efficiency index of the container placed on the heating region in real time by touching a specific button provided in the manipulation region 118.

For example, while a heating operation is performed after the user sets an output level to 7 in a state of placing the container on the heating region 16 selected by touching the heating region selection button 722c, the user may simultaneously touch a lock button 704 and a heating region selection button 722c to make a command of outputting the container efficiency index of the container placed on the heating region 16.

Based on the user's command, the controller 2 may calculate the container efficiency and display the calculated container efficiency index on the time window 730 for a preset time period (e.g., 3 seconds). As one example, when the calculated container efficiency index is 0.2, the controller 2 may display the number of ‘20’ or ‘2’ indicating that the current container efficiency index is 20% on the timer window 730.

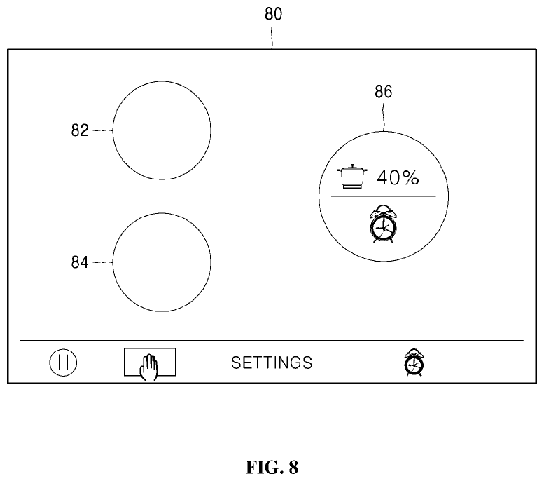

FIG. 8 shows a display provided in an induction heating device according to an embodiment.

As shown in FIG. 8, the induction heating device according to another embodiment may include a display 80 for displaying information related to the operation of the induction heating device, which is separately provided from the manipulation region 118 shown in FIG. 7. The display 80 may be realized by a display device such as a liquid crystal display (LCD), but the embodiment is not limited thereto.

The display 80 may display heating region icons 82, 84, 86 corresponding to the heating regions 12, 14 and 16, respectively. As described above, when the user makes the command of outputting the container efficiency index of the container placed on the heating region by touching the lock button 704 and the heating region selection button 722c at the same time or touching a separate button, the controller 2 may display the container efficiency index (e.g., 40%) for the container placed on the icon 86 corresponding to the heating region 16.

According to the embodiments, when the user makes the command of outputting the container efficiency index of the container placed on the heating region by using the predetermined button combination or the separate button, the corresponding container efficiency index may be displayed in real time on the manipulation region or the display.

As described above, the container efficiency index may be variable based on characteristics of the container. However, it may be impossible for the user to recognize its characteristics only from the outer appearance of the container or to directly recognize its characteristics in a process of cooking food using the container.

However, according to the embodiments, an accurate container efficiency index of the container currently heated on the heating region may be displayed in real time based on the user's request. Accordingly, the user may check the characteristics of the container very easily and quickly.

The embodiments are described above with reference to a number of illustrative embodiments thereof. However, the present disclosure is not intended to be limited to the embodiments and drawings set forth herein, and numerous other modifications and embodiments can be devised by one skilled in the art. Further, the effects and predictable effects based on the configurations in the disclosure are to be included within the range of the disclosure though not explicitly described in the description of the embodiments.

What is claimed is:

1. An induction heating device comprising:
an inverter to supply alternating current to a working coil and comprising a plurality of switches;
a drive circuit to supply a switching signal to the inverter for a switching operation of the plurality of switches; and
a controller configured to control driving of the working coil by supplying a control signal corresponding to a required power value of the working coil to the drive circuit,
wherein the controller is configured to drive the working coil based on the required power value, receive a resonance current value of the working coil when the working coil is driven, calculate a container efficiency index based on an output power value of the working coil, the required power value, the resonance current value and a preset limit current value, and control the driving of the working coil based on the container efficiency index.

2. The induction heating device of claim 1, wherein the container efficiency index is based on Equation 1 below:
PEI=(PR/PC)×(RI/CI) [Equation 1]
wherein PEI refers to the container efficiency index, PR refers to the output power value of the working coil, PC refers to the required power value of the working coil, RI refers to the preset limit current value, and CI refers to the resonance current value of the working coil.

3. The induction heating device of claim 1, wherein the controller is configured to compare the resonance current value to a preset first reference value, and when the resonance current value is greater than the preset first reference value based on the result of the comparison, the controller is configured to calculate the container efficiency index.

4. The induction heating device of claim 1, wherein the controller is configured to calculate an adjustment value based on the container efficiency index, and adjust the required power value by subtracting the adjustment value from the required power value.

5. The induction heating device of claim 4, wherein the adjustment value is based on Equation 2 below:
K=D/PEI [Equation 2]
wherein K refers to the adjustment value, D refers to a preset basic adjustment value, and PEI refers to the container efficiency index.

6. The induction heating device of claim 1, further comprising a cooling fan disposed on one side of the working coil,
wherein the controller is configured to adjust a rotational speed of the cooling fan based on the container efficiency index.

7. The induction heating device of claim 6, wherein the controller is configured to adjust the rotational speed of the cooling fan inversely proportional to the container efficiency index.

8. The induction heating device of claim 1, wherein when the container efficiency index is smaller than a preset third reference, the controller is configured to decrease a preset second reference, and
when the resonance current value is greater than the preset second reference value, the controller is configured to decrease the output power value of the working coil.

9. The induction heating device of claim 1, wherein when the required power value is determined, the controller is configured to increase the output power value until the output power value of the working coil becomes equal to the required power value, and
when the container efficiency index is smaller than a preset fourth reference value after the output power value becomes equal to the required power value, the controller is configured to adjust the output power value to be a value smaller than the required power value.

10. A method of controlling an induction heating device comprising:
driving a working coil based on a required power value;
measuring a resonance current value of the working coil when the working coil is driven;
calculating a container efficiency index based on an output power value of the working coil, the required power value, the resonance current value and a preset limit current value; and
controlling driving of the working coil based on the container efficiency index.

11. The method of controlling the induction heating device of claim 10, wherein the container efficiency index is based on Equation 1 below:
PEI=(PR/PC)×(RI/CI) [Equation 1]
wherein PEI refers to the container efficiency index, PR refers to the output power value of the working coil, PC refers to the required power value of the working coil, RI refers to the preset limit current value, and CI refers to the resonance current value of the working coil WC.

12. The method of controlling the induction heating device of claim 10, further comprising:
calculating the container efficiency index when the resonance current value is greater than a preset first reference value.

13. The method of controlling the induction heating device of claim 10, wherein the controlling the driving of the working coil based on the container efficiency index comprises,
calculating an adjustment value based on the container efficiency index and adjusting the required power value by subtracting the adjustment value from the required power value.

14. The method of controlling the induction heating device of claim 13, wherein the adjustment value is based on Equation 2 below:
K=D/PEI [Equation 2]
wherein K refers to the adjustment value, D refers to a preset basic adjustment value, and PEI refers to the container efficiency index.

15. The method of controlling the induction heating device of claim 10, further comprising:
adjusting a rotational speed of a cooling fan disposed on one side of the working coil, based on the container efficiency index.

16. The method of controlling the induction heating device of claim 15, wherein the adjusting of the rotational speed of the cooling fan is inversely proportional to the container efficiency index.

17. The method of controlling the induction heating device of claim 10, wherein the controlling the driving of the working coil based on the container efficiency index comprises,
decreasing a preset second reference when the container efficiency index is smaller than a preset third reference and decreasing the output power value of the working coil when the resonance current value is greater than the preset second reference value.

18. The method of controlling the induction heating device of claim 10, wherein the driving the working coil based on the required power value comprises,
increasing the output power value until the output power value of the working coil becomes equal to the required power value, when the required power value is determined, and
adjusting the output power value to be a value smaller than the required power value, when the container efficiency index is smaller than a preset fourth reference value after the output power value becomes equal to the required power value.
